(19) United States
(12) Patent Application Publication
(10) Pub. No.: US 2007/0036975 A1
(43) Pub. Date: Feb. 15, 2007

(54) Glass fiber composite and method of making glass fiber composites using a binder derived from renewable resources

(76) Inventors: Philip Francis Miele, Highlands Ranch, CO (US); Diana Kim Fisler, Littleton, CO (US)

Correspondence Address: JOHNS MANVILLE, 10100 WEST UTE AVENUE, LITTLETON, CO, 80127, US

(21) Appl. No.: 11/199,929

(22) Filed: Aug. 9, 2005

(51) Int. Cl. B05D 5/06; B05D 1/18; D02G 3/00

(52) U.S. Cl. 428/375; 427/434.6; 427/163.2; 427/372.2

(57) ABSTRACT

The use of thermosetting binder systems in the manufacture of glass fibers and composites manufactured from glass fiber is disclosed, and in particular, thermosetting binder resins derived from renewable resources that are useful as replacements for formaldehyde-based binders in non-woven fiberglass goods.

### FIELD

The following discloses the use of thermosetting binder systems for use in the manufacture of composites from glass fiber. More particularly, the following pertains to thermosetting binder resins derived from renewable resources that are useful as binders in non-woven fiberglass goods.

### BACKGROUND

Processes for producing glass fibers are well established and documented. In the rotary process, a stream of molten glass is delivered to an open spinning disc containing multiple orifices that causes fibers to extrude from the disc sidewall. The extruded fibers are directed downwardly toward a moving chain by pressurized air from nozzles in an annular ring positioned above the disc or by the jet blast of a gaseous combustion system. As the fibers fall from the spinning disc a rotating column of glass fiber is formed, which is sprayed with binder that is later heat cured in an oven. In the flame attenuation process, a coarse primary filament is drawn from a viscous silicate melt. Course fiber is then remelted and attenuated into many fine fibers. High velocity gases propel the fine glass fibers through a forming tube where a binder is applied. The coated fibers are deposited on a collecting chain where they entangle to produce a wool. Other glass fiber forming processes known in the art include fiber blowing processes, wheel centrifuge processes, and Downey processes. Acceptable binders coat the glass fibers in such a way as to provide strength and stiffness to the bonded glass fiber composition. The final products consist of bonded fiber glass batts, blankets and rolls employed in thermal and/or acoustical applications in residential or commercial buildings. Glass fiber based and/or reinforced products are also often found in original equipment manufacturer and other industrial applications.

In recent years the response to concerns over formaldehyde in building products has grown significantly. The Federal Environmental Protection Agency regulates the fiber glass manufacturing emissions of formaldehyde through the Maximum Achievable Control Technology Standards section of the Clean Air Act while the Occupational Safety and Health Administration and other Federal agencies regulate the workplace and product off-gassing of formaldehyde from insulation products made with traditional phenol formaldehyde binders. Formaldehyde has long been suspected as a probable human carcinogen and has been known to cause eye and throat irritations as well as respiratory aggravation. In June 2004, the International Agency for Research on Cancer, a division of the World Health Organization, classified formaldehyde as a known human carcinogen, a classification that likely will lead to further restrictions on human exposure to formaldehyde.

In response to concerns over exposure of formaldehyde in the environment, to factory workers employed in its use, and ultimately the consumers of products containing it, formaldehyde free thermoset binders have been developed and are employed to make the aforementioned products. The compositions of these developments are described in numerous patents, such as U.S. Pat. No. 5,661,213 to Arkens, U.S. Pat. No. 5,318,990 to Strauss, and U.S. Pat. No. 6,331,350 to Taylor et al. The Arkens, Strauss, and Taylor patents can be summarized as describing thermoset binder systems, free of any formaldehyde containing or generating components, and comprising a low molecular weight polycarboxylic acid, such as polyacrylic acid, and a polyol, such as triethanolamine, and phosphorus based catalyst.

While these formulations have proven successful in the production of fiber glass insulation materials, there still remains strong dependence on crude petroleum for the basic raw materials as well as a price structure highly impacted by crude oil prices. Although the reserves of crude oil appear to be plentiful in the future, the availability and price is controlled by the Organization of the Petroleum Exporting Countries. The acrylic based binders are more costly than traditional phenol formaldehyde binders and have been subjected to higher price increases. In addition, there a limited number of producers that manufacture the basic chemicals used to produce polycarboxylic acid. Therefore, a need exists for a thermosetting binder comprised of readily available, i.e. renewable, resources at a lower cost when compared to acrylic binders.

Vegetable oil derivatives have been used to supplement petroleum-based products in a variety of applications. Soy protein derived from soybeans has long been known as an additive and component in adhesive formulations, specifically wood adhesives. The high protein content of soybean makes for an excellent source of biopolymer material. While having excellent dry strength, typically biopolymer-based adhesives do not retain high strength when exposed to wet or humid conditions. For a binder to be acceptable as a fiber glass binder, it must be able to retain strength when exposed to wet or humid conditions so that compression packaged fiber glass will achieve a recovered thickness after installation and satisfy the specified thermal value.

The worldwide availability of soybeans, and thus soy protein, and the need for improved biopolymer-based adhesives has lead to the development of enhanced adhesive formulations derived from soy protein capable of achieving high strength in wet or humid conditions. Recent developments in the area of soy-based adhesives have focused on uses in the manufacture of wood-derived products. U.S. Pat. No. 6,719,882 issued to Vijayendran et al. describes a resin-binder system prepared by hydrolyzing protein to produce protein hydrosylates which are then mixed with a synthetic resin to produce a resin binder. U.S. Pat. No. 6,306,997 issued to Kuo et al., incorporated herein by reference, describes a soybean-based adhesive resin useful as a replacement for urea-formaldehyde resins in the manufacture of wood composite panel products. U.S. Pat. No. 6,790,271 issued to Thames et al., incorporated herein by reference, describes a mixture of soy protein isolate, polyol plasticizer, and vegetable oil derivative useful as an adhesive in the formation of particleboard and other wood composites. U.S. Patent Application Publication No. 2004/0089418, incorporated herein by reference, also contains further details of soy-derived adhesive technology which comprises improved thermosetting adhesives consisting of soy protein isolate or kraft lignin treated with a crosslinking agent.

The development of agriculturally based binders to replace conventional binder systems in the formation of glass fiber composites would represent a significant advancement in the art. This disclosure is directed to manufacturing methods for forming glass fiber products utilizing renewable resources in the form of agriculturally based binders in the manufacturing process. A method for forming glass fiber composites using an agriculturally based binder is disclosed and claimed herein.

### SUMMARY

A method for forming a glass fiber composite by applying an agriculturally based binder to a glass fiber substrate and curing the resulting glass fiber composite to form a glass fiber article is disclosed. In one embodiment, the agriculturally based binder is derived from soy protein.

### DESCRIPTION OF EMBODIMENTS

Fiberglass binders have a variety of uses, including uses in fully cured systems such as building insulation. Fibrous glass insulation products generally comprise a glass fiber substrate of matted glass fibers bonded together by a cured thermoset polymeric material. Molten streams of glass are drawn into fibers of random lengths and blown into a forming chamber where they are randomly deposited as a mat onto a traveling conveyor. The fibers, while in transit in the forming chamber and while still hot from the drawing operation, are sprayed with an aqueous binder. The residual heat from the glass fibers and the flow of air through the fibrous mat during the forming operation are generally sufficient to volatilize water from the binder, thereby leaving the remaining components of the binder on the fibers as viscous or semi-viscous high solids liquid. The coated fibrous mat is transferred to a curing oven where heated air, for example, is blown through the mat to cross-link the components, cure the binder, and rigidly bond the glass fibers together. In the flame attenuation process, a coarse primary filament is drawn from a viscous silicate melt. Course fiber is then remelted and attenuated into many fine fibers. High velocity gases propel the fine glass fibers through a forming tube where a binder is applied. The coated fibers are deposited on a collecting chain where they entangle to produce a wool-like fiber composite. Other glass fiber forming processes known in the art include fiber blowing processes, wheel centrifuge processes, and Downey processes. The resulting glass fiber composite has a variety of applications, including uses as building and industrial insulation, and glass-based substrates useful in the manufacture of wall board facing, filter stocks, reinforcement scrims, and the like.

Fiberglass binders used in the present sense should not be confused with matrix resins which are an entirely different and non-analogous field of art. While sometimes termed “binders,” matrix resins act to fill the entire interstitial space between fibers, resulting in a dense, fiber reinforced product where the matrix must translate the fiber strength properties to the composite, whereas “binder resins” as used herein are not space-filling, but rather coat only the fibers, and particularly the junctions of fibers. Fiberglass binders are not directly analogous to paper or wood product “binders” where the adhesive properties are tailored to the chemical nature of cellulosic substrates. While many such resins are not suitable for use as fiberglass binders without modification, agricultural derived wood adhesives and binder share some common constituents that can be altered and adjusted for use with the manufacture of glass fiber composites.

Binders useful in fiberglass insulation products generally require a low viscosity in the uncured state, yet possess characteristics so as to form a rigid thermoset polymeric bond of the glass fibers when cured. A low binder viscosity in the uncured state is required to allow the glass fibers to bind correctly. Also, viscous binders commonly tend to be tacky or sticky and hence they lead to the accumulation of fiber on the forming chamber walls. This accumulated fiber may later fall onto the collected fibers causing dense areas and product problems. A binder which is rigid and insoluable when cured is required so that, for example, a finished fiberglass thermal insulation product, when compressed for packaging and shipping, will recover to its as-made vertical dimension when installed in a building. Water is used as a diluent with the polymer-forming components to form a binder.

From among the many thermosetting polymers, numerous candidates for suitable hermosetting fiberglass binder resins exist. Agricultural-based derivatives, with appropriate modifications, can make suitable precursors from which binder resins can be synthesized. In one embodiment, a binder resin is synthesized by combining an agricultural isolate with an appropriate compound having curing and adhesive properties. In another embodiment, a binder resin is synthesized by combining a vegetable protein with an appropriate compound having curing and adhesive properties. In an alternate embodiment, a binder resin is synthesized by combining a vegetable protein with one or more formaldehyde-free compounds having desirable curing and adhesive properties. As used herein, “FF” means “formaldehyde-free.” Since formaldehyde exists in nature, FF as used herein means that exogenous formaldehyde is not added to the binder resin. That is not to say, however, that formaldehyde endogenous to a compound, as a reactant bi-product or otherwise, has been removed from all compounds described herein. In another embodiment, the vegetable protein is a soy protein. In an alternate embodiment, a binder resin is synthesized by combining a vegetable protein isolate with one or more curing agents, including an amine, amide, imine, imide, or nitrogen-containing heterocylic functional group that can react with at least one functional group of the soy protein isolate. In yet another embodiment, the amine is a di- or multi-functional primary or secondary amine. In another embodiment, the di- or multi-functional primary or secondary amine includes 1,2-diethylamine, 1,3-propanediamine, 1,4-butanediamine, 1,5-pentanediamine, 1,6-hexanediamine, piperazine, 4,4′-xylenediamine, diethylenetriamine, triethylenetetramine, tetraethylenepentamine, and mixtures thereof.

Soy proteins can be prepared for use in a fiber glass binder and combined with other compounds to form adhesive compositions. Inter- and intra- molecular hydrogen bonds inherent in soy proteins can be disrupted through the use of plasticizers such as polyhydric alcohols. Numerous polyols are suitable for use as plasticizers, including, but not limited to, hexanediols, hexanols, butanediols, propanediols (such as trimethylol propane), propanetriols (such as glycerol), and ethanediols. While plasticizers improve molecular mobility at high temperatures, plasticizers reduce T_{g}. To counteract a polyol effect on T_{g}, other compounds can be added to soy protein-based fiber glass binder resins to improve rigidity after a fiber glass composite has been cured. Lignins, calcium arbonate, and silicates are all known adhesive stiffeners. Other compounds, such as adhesion promoters, oxygen scavengers, moisture repellants, solvents, emulsifiers, pigments, fillers, anti-migration aids, coalescents, wetting agents, biocides, plasticizers, organosilanes, anti-foaming agents, colorants, waxes, suspending agents, anti-oxidants, silanes, and crosslinking catalysts, can be added to the binder resin to improve its properties as a glass fiber resin. In one embodiment, a soy-based adhesive is synthesized with one or more compounds having desirable curing, adhesive, and stiffening properties. In another embodiment, the silane is an organosilane. As mentioned above, multiple examples of soy-based binder systems and related additives are known in the art (U.S. Pat. No. 6,719,882; U.S. Pat. No. 6,306,997; U.S. Patent No. 6,790,271; U.S. Patent Application Publication No. 2004/0089418), and such additives may be used to improve the properties of the general compositions for use as a binder system for the formation of fiber glass composites.

### EXAMPLE

To form a fiber glass composite, molten streams of glass can be drawn into fibers of random lengths and blown into a forming chamber where they can be randomly deposited as a mat onto a traveling conveyor. The fibers, while in transit in the forming chamber and while still hot from the drawing operation, can be sprayed with an aqueous soy-based binder. The residual heat from the glass fibers and the flow of air through the fibrous mat during the forming operation can be generally sufficient to volatilize water from the binder, thereby leaving the remaining components of the binder on the fibers as viscous or semi-viscous high solids liquid. The coated fibrous mat can be transferred to a curing oven where heated air, for example, is blown through the mat to cure the binder and rigidly bond the glass fibers together.

Principles, embodiments, and modes of operation of the present invention have been described in the foregoing specification. The invention which is intended to be protected herein, however, is not to be construed as limited to the particular forms disclosed, since these are to be regarded as illustrative rather than restrictive. Variations and changes may be made by those skilled in the art without departing from the spirit of the invention.

What is claimed is:

1. A method comprising:
a) forming glass fiber substrate;
b) applying a binder composition to the glass fiber substrate to form an uncured glass fiber batt, wherein the binder comprises: i) agricultural isolates; ii) at least one formaldehyde-free curing agent; and iii) an organosilane; and
c) curing the glass fiber batt to form a glass fiber composite.

2. The method according to claim 1, wherein the uncured glass fiber batt has a moisture content of about 3 percent to about 10 percent by weight.

3. The method according to claim 1, wherein the agricultural isolates are derived from a vegetable protein isolate.

4. The method according to claim 3, wherein the vegetable protein isolate is a soy protein isolate.

5. The method according to claim 4, wherein the formaldehyde-free curing agent is selected from the group consisting of an amine, an amide, an imine, an imide, a nitrogen-containing heterocylic functional group that can react with at least one functional group of the soy protein isolate, and mixtures thereof.

6. The method according to claim 4, wherein the formaldehyde-free curing agent includes at least one amine, amide, imine, imide, or nitrogen-containing heterocylic functional group that can react with at least one functional group of the soy protein isolate.

7. A method for binding glass fiber comprising applying to uncured glass fiber a coating of a composition comprising: i) agricultural isolates; ii) at least one substantially formaldehyde-free curing agent; and iii) an organosilane, and thereafter curing said composition while present as a coating on said glass fiber to adhere said glass fiber.

8. The method according to claim 7, wherein the uncured glass fiber composition has a moisture content of about 3 percent to about 10 percent by weight.

9. The method according to claim 7, wherein the agricultural isolates are derived from a vegetable protein isolate.

10. The method according to claim 9, wherein the vegetable protein isolate is a soy protein isolate.

11. The method according to claim 7, wherein the formaldehyde-free curing agent is selected from the group consisting of an amine, an amide, an imine, an imide, a nitrogen-containing heterocylic functional group that can react with at least one functional group of the soy protein isolate, and mixtures thereof.

12. The method according to claim 7, wherein the formaldehyde-free curing agent includes at least one amine, amide, imine, imide, or nitrogen-containing heterocylic functional group that can react with at least one functional group of the soy protein isolate.

13. The method for binding glass fiber according to claim 12, wherein said amine is a di- or multi-functional primary or secondary amine.

14. The method for binding glass fiber according to claim 13, wherein said di- or multi-functional primary or secondary amine is selected from the group consisting of 1,2-diethylamine, 1,3-propanediamine, 1,4-butanediamine, 1,5-pentanediamine, 1,6-hexanediamine, piperazine, 4,4′-xylenediamine, diethylenetriamine, triethylenetetramine, tetraethylenepentamine, and mixtures thereof.

15. The method for binding glass fiber according to claim 13, wherein said amine is selected from the group consisting of 1,2-diethylamine, 1,3-propanediamine, 1,4-butanediamine, 1,5-pentanediamine, 1,6-hexanediamine, α,α′-diaminoxylene, diethylenetriamine, triethylenetetramine, tetraethylenepentamine, and mixtures of these.

16. A curable composition for the binding of glass fiber according to claim 7, further comprising at least one component selected from the group consisting of adhesion promoters, oxygen scavengers, moisture repellants, solvents, emulsifiers, pigments, fillers, anti-migration aids, coalescents, wetting agents, biocides, plasticizers, organosilanes, anti-foaming agents, colorants, waxes, suspending agents, anti-oxidants, and crosslinking catalysts.

17. A formaldehyde-free fiberglass product formed by the process of claim 7.

18. A formaldehyde-free fiberglass product formed by the process of claim 14.

19. A fiberglass product according to claim 17 wherein the product is building insulation.

20. A fiberglass product according to claim 18 wherein the product is building insulation.

21. A fiberglass product formed by the process of claim 17, wherein the product is a glass-based non-woven substrate useful for any of a wall board facing, filter stock, or reinforcement scrim.

22. A fiberglass product formed by the process of claim 18, wherein the product is a glass-based non-woven substrate useful for any of a wall board facing, filter stock, or reinforcement scrim.
